(19) United States
(12) Patent Application Publication
(10) Pub. No.: US 2006/0095329 A1
(43) Pub. Date: May 4, 2006

(54) System and method for providing online travel-related services coupled with targeted advertising

(76) Inventor: Cy Chooyoun Kim, San Jose, CA (US)

Correspondence Address: Cy C. Kim, 1224 Royal Crest Drive, San Jose, CA, 95131, US

(21) Appl. No.: 11/266,137

(22) Filed: Nov. 2, 2005

Related U.S. Application Data
(60) Provisional application No. 60/624,944, filed on Nov. 3, 2004.

(51) Int. Cl. G06Q 10/00

(52) U.S. Cl. 705/14; 705/5

(57) ABSTRACT

A system and method for providing online services for air travelers coupled with providing targeted advertising for online advertisers. More particularly, the invention allows air travelers to select online their seats, seatmates, or both, while at the same time allowing advertisers to target these travelers based on any combination of user attributes made available from their flight information and personal profiles.

### CROSS-REFERENCE TO RELATED APPLICATIONS

This application is entitled to the benefit of Provisional patent application Ser. No. 60/624,944 filed Nov. 3, 2004.

### FEDERALLY SPONSERED RESEARCH

Not Applicable

### SEQUENCE LISTING OR PROGRAM

Not Applicable

### FIELD OF THE INVENTION

The present invention relates to a system and method for providing travel-related online services, coupled with targeted advertising based on user' travel information and personal profile information.

### BACKGROUND OF THE INVENTION

Online travel and targeted advertising are two components of the Internet that are currently thriving. However, up until the present invention the two had not been combined effectively to maximize their advantages. There are many travel-related services available online that can yield information as to the future time and location of their users. For example, flight reservations, bus or train ticket purchases, and hotel reservations all reveal a likely future location and time of their purchaser. This information can be gathered together from being coupled to an online travel-related service to produce a valuable targeting mechanism for ads. Seat selection and seatmate selection are two such services.

I. Seat Selection

The airlines industry is in the midst of a financial crisis as many of the largest airlines are constantly on the verge of bankruptcy. The only airlines that have been thriving in the current market are low-fare airlines like Southwest, whose business model allows them to cut many of the costs incurred by traditional major airlines. One of the other ways that Southwest Airlines is able to cut costs is by having an open seating system. Whereas all of the traditional major airlines have assigned seating systems, Southwest allows passengers to choose from any available seat as they board the plane. This measure allows for faster turnaround times at the gates for boarding, eliminates expenses associated with assigned seating systems, and frees Southwest to employ a simpler, more cost-effective inventory system for their distribution system.

Not everyone is a fan of the open seating policy, derisively dubbed “the cattle call.” Its detractors complain about the rush to get in line and the long wait required to get the best seats. Despite the many customer complaints it receives, Southwest has thus far remained steadfast in keeping its open seating policy and the resultant cost benefits. Conversely, due to customer demand, traditional major airlines have been unable to copy Southwest by switching to an open seating policy, even though it is more cost-effective. An assigned seating system with lower costs or even profit potential would be a boon for the struggling airline industry.

The emergence of the Internet has also benefited air travelers by making available new online services and features. Before the Internet, only travel agents could book seats and submit limited seating requests, such as window or aisle seats. Many airline and travel sites today allow ticket purchasers to view the seating layout of their flights and select their seats from the ones still available. There are even websites where travelers can look up the seating layouts of planes and gain insights as to which are the best and worst seats.

II. Seatmate Selection

Seat selection may play a significant role in the level of comfort enjoyed by air passengers, but another factor with equal, if not greater, impact is the passenger sitting in the adjacent seat. Few things have more potential to influence the flight experience of a passenger, for better or for worse, than the person sitting right beside that passenger for the entire duration of the flight. An agreeable person in the next seat can greatly enhance the flight experience, while an incompatible personality can certainly detract from that experience. For such a significant factor, the “compatible seatmate” also represents a wide-ranging variable dependant upon each traveler's personality, preferences and circumstances.

Some travelers may just be looking for a peaceful flight, such as introverts who are more at ease keeping to themselves, business travelers with work to accomplish during the flight, or anyone else simply tired and needing rest. Others may desire to have more interactions with their seatmates. An extrovert may seek another extrovert to engage in conversations, or an introverted individual wanting to socialize may prefer someone extroverted who will jump-start conversations.

In addition, for these individuals who want to actively engage one another, the quality of their interactions could depend on how compatible they are personality-wise. If they could be matched up together based on complementary traits or commonalities such as shared interests, sense of humor, personal politics, favorite sports teams, etc., there would be a greater likelihood of them establishing a rapport and having a pleasant exchange throughout the flight. Also, some passengers may be interested in meeting people for purposes beyond mere conversations during the flight. For example, some might be interested in making business contacts for their careers, while others may be looking for friendship or romance. For such individuals, if they had a way of knowing who else was going to be on their flight and the means to contact a person of interest and arrange to sit together, each flight would present a valuable social or professional meeting opportunity that is not purely dependent on chance.

Allowing passengers to choose or have some input in selecting their seatmates would increase the likelihood of a pleasant flight experience while offering them a novel way to meet new people based on their personal preferences and objectives. As of November 2005, we have become aware of two businesses that aim to connect air travelers: Flight-Club.org and Airtroductions.com. Neither of these sites offer seat selection services or targeted advertisements.

III. Online Advertising

With the rapid emergence of the Internet, the World Wide Web has become one of the fastest-growing mediums for advertisements. As online advertisers seek to maximize returns for their ad dollars, they are very concerned with targeting the right audience. Besides advertising on websites with the desired demographic of visitors, advertisers are looking to new methods and technologies to help them reach their target audience with more precision.

Some advertisers use information collected from web users (via cookies, spyware, voluntary submissions, etc.) to match their ads with users who fit the desired profile. Search-based advertising is another popular method where advertisers bid for keywords related to their businesses to target users who submit those same keywords to search engines. Finally, another useful way for advertisers to break down the web audience into relevant segments is by geographical locations.

Most businesses are local in nature and have little to gain by advertising to the general audience beyond their market reach. The most obvious and common way for these businesses to connect with their local markets online is by advertising on popular local websites. In addition, search engines have been recently adding a feature where users can conduct localized searches by entering, along with their keywords, their geographical information such as city and state, zip code, telephone area code, or county name. Users' IP addresses can also divulge the users' physical locations at times. The additional information pertaining to the user's location allows advertisers to select their audience by both keywords and physical locality. Lastly, another known method of geographically targeting online ads involves the use of wireless devices that connect to the Internet and technologies which can track the locations of these devices, such as the Global Positioning System (GPS). The coupling of these two technologies enables an advertiser to target those wireless devices that are found within the vicinity of the advertiser's business.

All these solutions are designed to reach audiences presently located in a specified geographical region. However, they are less effective in reaching people who are not currently situated in that locality, but will be arriving at some time in the future. For example, people who are not current residents of a certain geographical area are not likely to be familiar with the popular local websites of that region. Thus, the chances are remote that they will visit these websites before arriving at that region. Furthermore, those who are located in one region are less likely to perform localized searches for another region on search engines. Any such searches will be limited to those that can be anticipated by people who plan ahead before arriving at their destination. Finally, by design, people connected to the Internet through wireless devices will only receive the localized advertisements when their presence within the designated area is detected by the location tracking technologies.

However, many businesses have a great deal of interest in reaching not only those who are currently located in their geographical markets, but also those who will be arriving at some point in the future. For example, it would be highly advantageous for businesses that rely heavily on tourist dollars to advertise to visitors from all over the world who will be coming to their locality. Additionally, there are some advertisers, such as organizers of fairs and festivals, who are interested in people who will be arriving at their geographical areas during certain time frames. For these businesses to advertise nationally or globally would be a costly and highly inefficient means of reaching their narrow audience.

Sabre's “Virtually There” is the closest alternative currently available for advertisers wanting to target future visitors of the advertisers' geographical markets. When a traveler books a flight off-line through a Sabre travel agent, the agent will email a unique URL address to the traveler which links the traveler to the flight itinerary as well as contextually relevant, strategically placed ads on VirtuallyThere.com. Advertisers can target travelers by using criteria such as origination city, destination city, airline, class of service, gender, departure date, arrival date, and length of stay. However, “Virtually There” only targets travelers who book their tickets off-line. There is currently no comparable service to target travelers who book their tickets online. In addition, there is no guarantee when, if ever, the traveler will visit the URL and view the advertisements.

### BACKGROUND OF INVENTION—OBJECTS AND ADVANTAGES

It is one of the objects and advantages of the present invention to give advertisers a precise and cost-effective way to reach these future visitors at a critical time when the visitors are making plans and arrangements to visit their locale. For example, a Las Vegas resort could advertise to everyone flying into McCarran up through November a promotional package that includes tickets to its current show, and advertise a different promotion featuring its new show starting in December to everyone arriving thereafter. In addition, they can advertise “high roller” packages with executive suites to just those flying in first class. A bed and breakfast in Miami could target everyone flying into Southern Florida. Organizers of the Gilroy Garlic Festival can opt for everyone flying into the Bay Area the week of the festival. A nightclub in New York could specify singles flying into the city. Ads need not be location specific, and Palm will have the flexibility to introduce its latest rendition of the Treo smartphone to everyone sitting in business class.

It is another object and advantage of the present invention to provide all air passengers with a more comfortable journey, whether they are looking for peace and quiet, an engaging conversation, or a professional, social, or romantic relationship to extend beyond the flight's journey.

A further objective and advantage of the present invention is to offer airlines a more cost effective or profitable system for employing an assigned seating system

Still further objects and advantages will become apparent from a consideration of the ensuing description and drawings.

### SUMMARY

I have invented a system and method for providing online travel-related services coupled with providing targeted advertising based on travel and personal information. More particularly, the invention gives airline travelers the means to select their seats and seat companions online while providing advertisers the means to target these travelers based on any combination of specific attributes. These attributes can include time, location, and other information that can be deduced from their flight data, as well as any other information submitted by the travelers intended to help them in the seatmate selection process.

### BRIEF DESCRIPTION OF THE DRAWINGS

FIG. 1 shows the architecture of the system in its preferred embodiment.

FIG. 2 is a flowchart of the air traveler's user experience of the system in its preferred embodiment.

FIG. 3 is a flowchart of the advertiser's user experience of the system in its preferred embodiment.

FIG. 4 shows a sample flight page of the preferred embodiment.

FIG. 5 shows a new user sign-up profile page of the preferred embodiment.

FIG. 6 shows the flight-specific preferences page of the preferred embodiment.

FIG. 7 shows the main menu homepage of the preferred embodiment.

FIG. 8 shows a hypothetical scenario of targeted bidding by advertisers for illustrative purposes.

### DESCRIPTION

The system is employed over the Internet, where travelers on clients connect to a web server and enter their flight information as well as any additional information intended to aid in the selection of a compatible seatmate. The web server utilizes databases which contain information related to flights and their passenger lists, the individual profiles of the passengers containing their personal preferences, and advertisers' ads with their targeting criteria. Based on each traveler's input, the web server performs the requested service for the traveler and returns to the client appropriate service content as well as targeted advertising when there is a match between user input and an advertiser's targeting criteria.

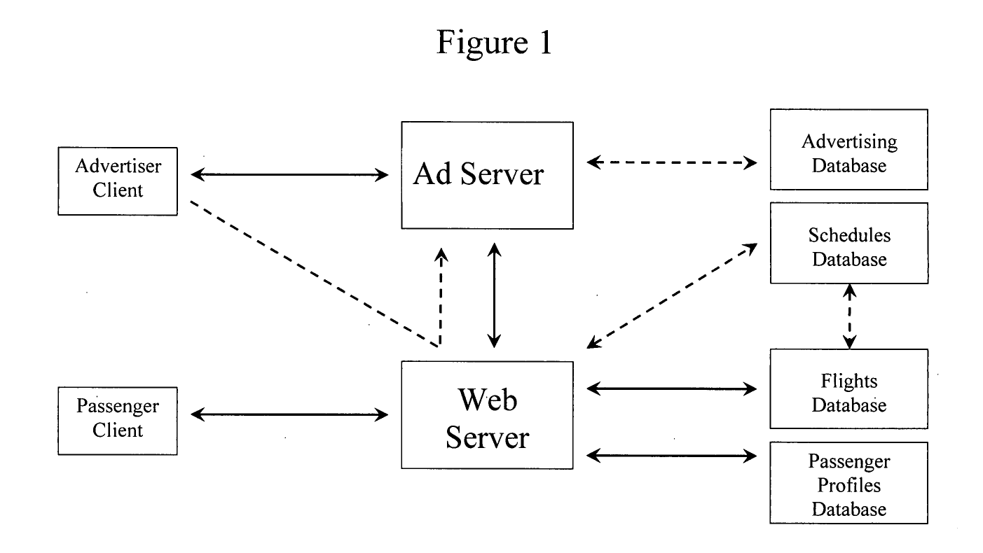

FIG. 1 shows the architecture of the preferred embodiment as it is to be deployed over the Internet. An advertiser on a client connects to the ad server over the Internet directly or after being directed there from the web server. The advertiser enters all relevant information regarding his or her ad, including all parameters and targeting criteria, which are stored on the ad server or the ad database. A traveler user on a client connects to the web server over the Internet and enters his or her flight information. The web server then accesses the flights database to retrieve information about the flight, including schedules and passenger lists. Ideally, there is also a schedules database which can keep the flights database updated on any changes in flight scheduling. The traveler user also performs a login, at which point the user's saved profile is retrieved from the passenger profiles database, or for first-time users, a new profile is created in the database. The flight information and user profile is shared by the web server with the ad server, allowing the ad server to return the appropriate, relevant ads to the web server according to the advertiser's targeting criteria. The web server then sends targeted ad content along with all the service content to the client of the traveler user.

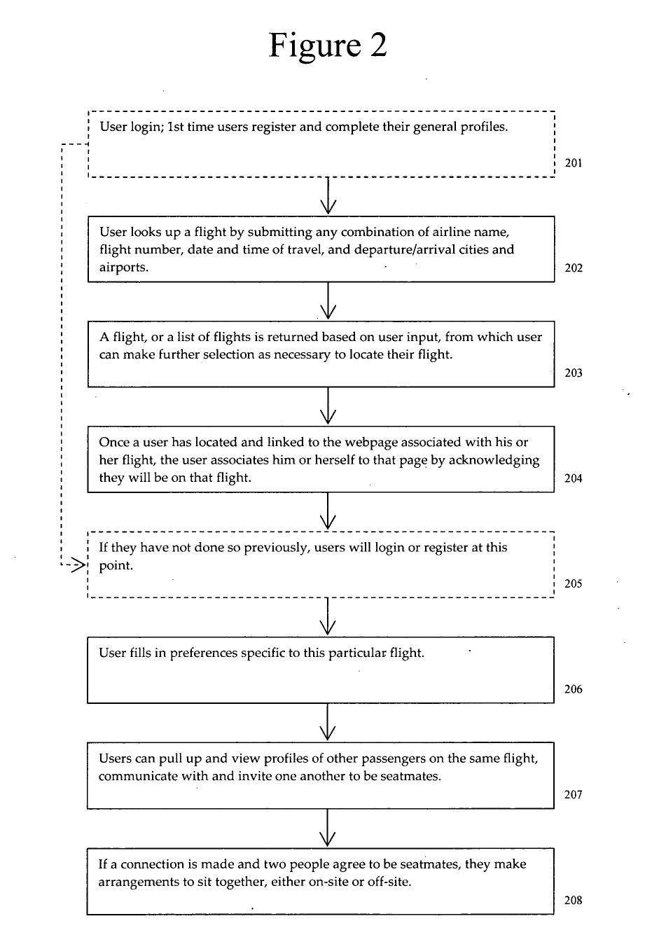

FIG. 2 is a flowchart of the air traveler's user experience of the seatmate selection process in the preferred embodiment. The user can begin by logging in at the start (at step 201), or the user can login at a later point (step 205). The seatmate selection process starts with the user submitting any combination of identifying information regarding his/her flight intended to help the server pull up the right flight page (step 202). The server returns to the user the appropriate flight page, or if more than one flight matches user input, a list of flights from which the user can select the correct flight (step 203). Once a user has linked to the correct flight page, the user associates himself or herself to that page by acknowledging he or she will be on that flight (step 204). At this point, if they have not done so previously, users will be asked to log in and, for first time users, complete a profile form (step 205). Next, the user will fill in their flight specific preferences (step 206). Finally, in step 207, users may pull up and browse the profiles of other passengers on their flight. If they find a promising potential seatmate, they may communicate with that person through the website and/or invite that person to be their seatmate. If a connection is made and two people agree to be seatmates, the final step is for them to make arrangements to sit together, either through the website or off-site on their own (step 208).

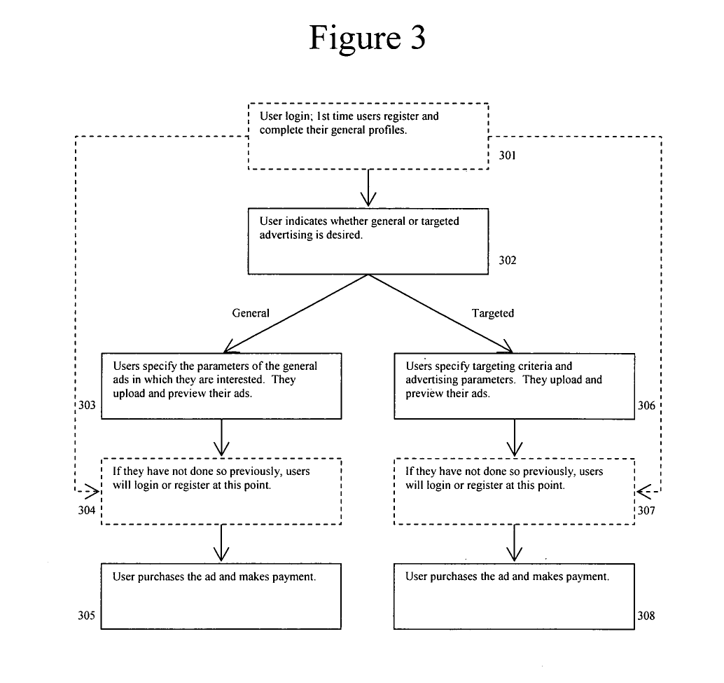

FIG. 3 is a flowchart of the advertiser's user experience in placing an order for advertisements in the preferred embodiment of the system. The user can begin by logging in at the start (at step 301), or the user can login at a later point (steps 304 or 307). At step 302, the user must specify whether they want to purchase general ads or targeted ads. If general ads are selected, the user will encounter step 303 where he or she must specify the parameters of the ad and agree to a purchase price. They will also upload and preview their ads at this step. If they have not already logged in by this point, they will be required to do so, and first time users must register and create an account which includes payment information (step 304). Finally, the user will review their order information and formally agree to the transaction (step 305). If, however, targeted ads were selected at step 302, the user will be taken to step 306, where they will specify their desired targeting criteria, bid amounts, and other advertising parameters. They will also upload and preview their ads at this step. If they have not logged in by this point, they will be required to do, and first time users must register and create an account which includes payment information (step 307). In the final step 305, the user will review their order information and formally agree to the transaction.

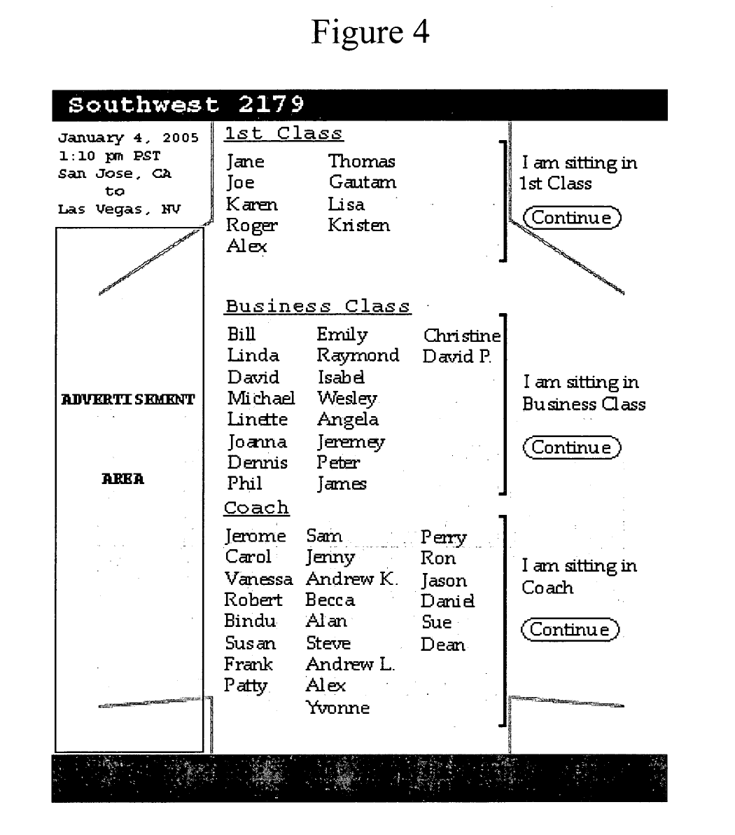

FIG. 4 shows a sample flight page of the preferred embodiment. Each flight page will prominently identify the flight airline and number, as well as other flight information, including date, time, and cities. It will also display the first names and possibly last initials of passengers on that flight who are interested in finding compatible seatmates. These names will be divided into separate sections if the flight has more than one class of seats. There will be buttons that users can click to easily associate themselves with the flight or a certain section of the flight. There will also be a portion of the page set aside for targeted advertisements.

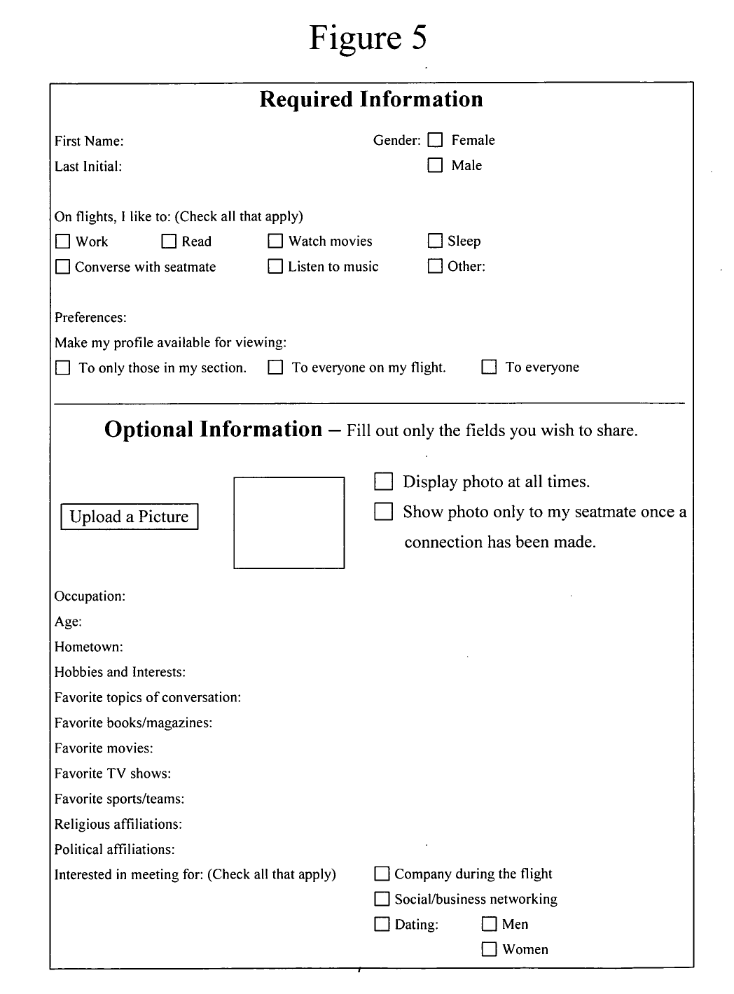

FIG. 5 shows a new user sign-up profile page of the preferred embodiment. Each user profile, which is to be stored in a database, is divided into two parts. There is a required information section where completion is mandatory, and there is an optional information section where the users decide how much, if any, additional information they want to provide.

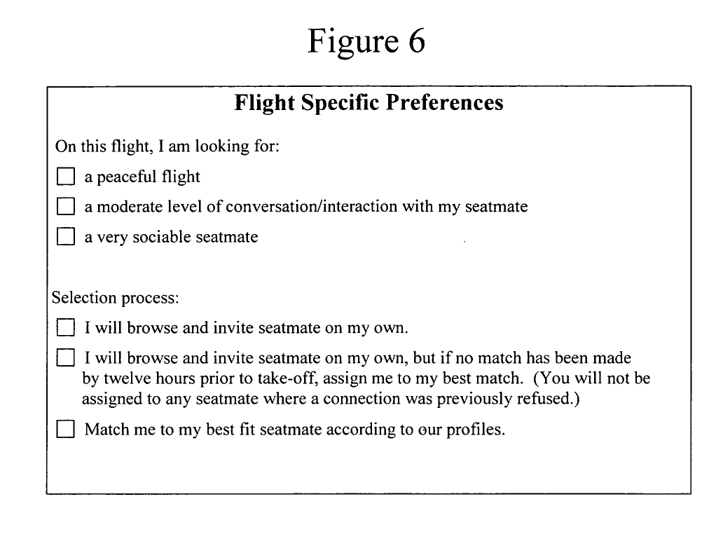

FIG. 6 shows the flight-specific preferences page of the preferred embodiment. This is a mandatory section where users must specify their preferences for this particular flight. Here, the user also has the option of having a computer assigned seatmate based on compatibility.

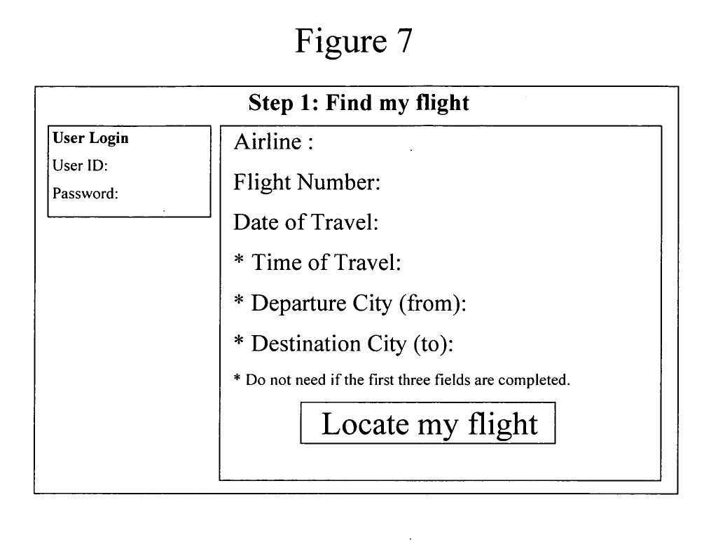

FIG. 7 shows the main menu homepage of the preferred embodiment. The users can log in right away, or they can start by first looking up their flight by entering their flight information.

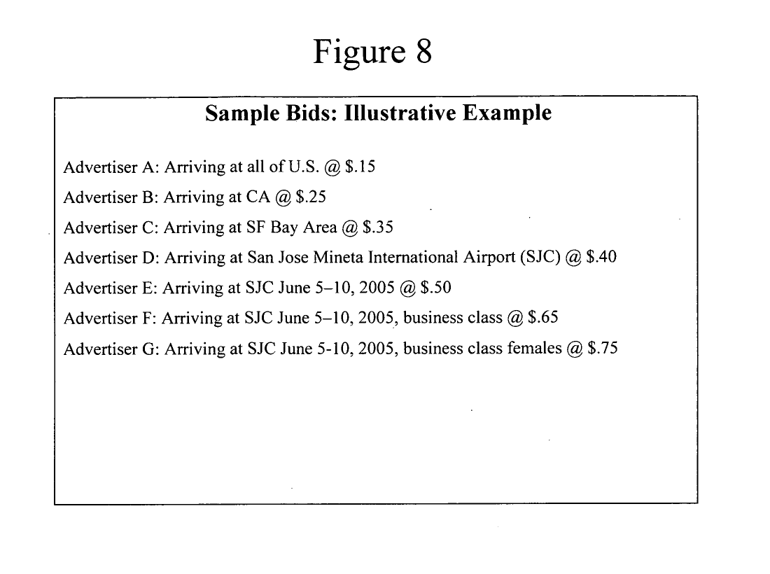

FIG. 8 shows a hypothetical bidding scenario for targeted ads. To simplify the illustration, we will assume that there is only one winner, the highest bidder, for each traveler. Advertiser A would win and his ad would be displayed to everyone arriving at any state in the U.S. except for California. Advertiser B's ad would be displayed to everyone arriving in California except those arriving at Bay Area airports. Advertiser C's ads would be displayed to all those arriving at Bay Area airports except for those landing at San Jose's Mineta International Airport (SJC). Advertiser D's ads would be displayed to everyone arriving at SJC except for those arriving there Jun. 5^{th} through 10^{th}, 2005. Advertiser E's ads would be displayed to everyone arriving at SJC between Jun. 5^{th} and 10^{th}, 2005, except for those sitting in business class of those flights. Advertiser F's ads would be displayed to all business class passengers arriving at SJC between Jun. 5^{th} through 10^{th}, 2005, except for the female business class passengers. Finally, Advertiser G's ads would be displayed to all female business class passengers arriving at SJC between Jun. 5-10, 2005. Adding to the hypothetical, if a new Advertiser H came along and wanted to target all passengers who had identified themselves as a doctor or physician at a price of $1, then all the previous advertisers would lose passengers who had identified themselves to be a doctor or physician in their profiles to Advertiser H.

The invention can be comprised of 1) seat selection and targeted advertising services, 2) seatmate selection and targeted advertising services, or 3) seat selection, seatmate selection, and targeted advertising services.

In its various embodiments, this invention can be implemented for each individual airline, or over multiple airlines. If seat selection is involved, users can hyperlink straight from their ticket purchase pages to their flight pages to make their seat selections. If users choose not to do so at the time of the purchase, or if they purchase their tickets off-line, they can visit the website at a later time and type in their reservation numbers or other flight information to access their flight pages and make their seat selections. If seatmate selection service is also offered, the users will also have the option of selecting seatmates on the flight pages as described above. Furthermore, users will be able to login and update their profiles or preferences as they change. All advertising models known in the arts can be employed in alternative embodiments of the invention, not just the general flat fee and pay-per-click models. A feedback section can be added to the personal profiles page where other travelers can comment on their flight experiences sitting next to that person. On a flight with multiple legs, an option may be added where travelers can pull up all the legs of their flight by entering their booking or reservation number, rather than having to look up each leg individually.

While embodiments and implementations of the invention have been shown and described, it should be apparent that many more embodiments and implementations are within the scope of the invention. Accordingly, the invention is not to be restricted, except in light of the claims and their equivalents.

I claim:

1. A method of providing travel-related services coupled with targeted advertising over a network, comprising:
maintaining a first database of ads and their targeting criteria;
receiving a request to perform an operation linked to the travel-related services from a user over the network;
performing the said operation;
analyzing the said request to gather information regarding the characteristics of the said user;
checking the said information with the said first database to identify the appropriate matching ads;
returning the said appropriate matching ads along with the performed said operation back to the said user over the network.

2. The method of claim 1, further comprising: maintaining a second database of user-volunteered personal profiles from which additions can be made to said information about said user, if the said user associates with one of the said personal profiles.

3. The method of claim 2, wherein said targeting criteria is comprised of any combination of travel information and personal profile information, including geographical location of arrival, date of arrival, dates of stay, geographical location of departure, date of departure, fare class, gender, age, occupation, hobbies, interests, and relational status.

4. The method of claim 3, wherein said travel-related services deal with seat selection.

5. The method of claim 3, wherein said travel-related services deal with seatmate selection.

6. The method of claim 3, wherein said travel-related services deal with both seat selection and seatmate selection.

7. The method of claim 1, wherein said targeting criteria is selected from a group of travel information that includes geographical location of arrival, date of arrival, dates of stay, geographical location of departure, date of departure, and fare class.

8. The method of claim 7, wherein said travel-related services deal with seat selection.

9. A system for providing travel-related services coupled with targeted advertising over a network, comprising:
a web server for performing operations linked to travel-related services and providing resultant information to a first plurality of client users over the Internet in response to requests from the said first plurality;
an advertising server for providing advertising information to said first plurality over the Internet;
an advertising database for storing information including ads and their targeting criteria;
a first server side program, executed at the advertising server, to upload said ads and their targeting criteria to the said advertising database from a second plurality of client users over the Internet;
a second server side program, executed at the web server, for analyzing a user request from the first plurality, gathering data about user characteristics of said user from the analysis, and communicating said data to the said advertising server;
a third server side program, executed at the advertising server, for receiving said data from the web server, using said data to search the said advertising database for appropriate ads based on their targeting criteria; gathering said appropriate ads and communicating them to the web server;
a fourth server side program, executed at the web server, for receiving said appropriate ads, packaging said appropriate ads with said resultant information for a final set of information, and providing the said final set of information to said user from the first plurality over the Internet.

10. The system of claim 9, further comprising:
a user profile database for storing personal profile information of said first plurality of client users;
a fifth server side program, executed at the web server, for uploading and retrieving said personal profile information to and from said user profile database;
wherein the second server side program also determines from said user request if said user has a personal profile stored in the said user profile database, and uses the said personal profile when said personal profile exists in gathering said data about user characteristics.

11. The system of claim 10, wherein the advertising server is included in the web server.

12. The system of claim 9, wherein the advertising server is included in the web server.
